(19) United States
(12) Patent Application Publication
(10) Pub. No.: US 2022/0114356 A1
(43) Pub. Date: Apr. 14, 2022

(54) FINGERPRINT SENSING DEVICE

(71) Applicant: VISUAL SENSING TECHNOLOGY CO., LTD., Hsinchu City (TW)

(72) Inventor: Wei-Hung Hsu, Taoyuan City (TW)

(21) Appl. No.: 17/140,121

(22) Filed: Jan. 3, 2021

(30) Foreign Application Priority Data
Oct. 13, 2020 (TW) 109135321

(51) Int. Cl. G06K 9/00; G02B 5/30; G02B 3/00

(52) U.S. Cl. CPC G06K 9/0004; G02B 3/0006; G02B 5/3058

(57) ABSTRACT

The invention provides a fingerprint sensing device, which includes a display panel, a light sensor array, an optical path structure, a first pixelated polarizer array and a second pixelated polarizer array. The light sensor array includes a light sensor. The optical path structure is disposed between the display panel and the light sensor array. The first pixelated polarizer array is disposed on the optical path structure and includes a first pixelated polarizer. The second pixelated polarizer array is disposed on the display panel and includes a second pixelated polarizer. The first pixelated polarizer, the second pixelated polarizer and the light sensor overlap in a vertical projection direction, and a polarization direction of the first pixelated polarizer is the same as that of the second pixelated polarizer.

### BACKGROUND OF THE INVENTION

### 1. Field of the Invention

The present invention relates to a fingerprint sensing device, and more particularly, to a fingerprint sensing device that can be used to perform fingerprint identification.

### 2. Description of the Prior Art

Recently, smart phones having borderless full-screen and thinness appearance have become the mainstream trend. In addition, the awareness of personal privacy protection is rising, and the demand for the fingerprint identification function performed on the screen and through the glass without apertures is increasing as well.

Under considerations of thin smart phones, mass production and cost, methods such as pinhole imaging, single lens imaging and microlens array imaging are mainly used in the fingerprint identification imaging system of full-screen smart phones including thin film transistor liquid crystal displays (TFT-LCD) or active matrix organic light emitting diode (AMOLED) displays. Among them, devices of pinhole imaging and microlens array imaging can be mass produced in semiconductor manufacturing factories, thus the manufacturing efficiency is higher. However, due to characteristics of pinholes, most of the fingerprint reflected light is blocked from entering into the sensors in the pinhole imaging method, which leads to low brightness of the fingerprint image and poor identification efficiency. On the other hand, although the light receiving efficiency in the microlens imaging method is better than that of pinhole imaging method, there is still a problem of low image resolution to be overcome.

### SUMMARY OF THE INVENTION

The technical problem to be solved by the present invention is that the resolution of fingerprint images of the fingerprint sensing device is low and the identification efficiency is poor.

In order to solve the above-mentioned technical problem, a fingerprint sensing device is provided by the present invention. The fingerprint sensing device includes a display panel, a light sensor array, an optical path structure, a first pixelated polarizer array and a second pixelated polarizer array. The display panel includes a first side and a second side opposite to the first side. The light sensor array is disposed under the display panel, and the light sensor array includes a first light sensor. The optical path structure is disposed between the display panel and the light sensor array, the optical path structure includes a first side and a second side opposite to the first side, and the light sensor array is disposed on the first side of the optical path structure. The first pixelated polarizer array is disposed on the second side of the optical path structure, and the first pixelated polarizer array includes a first pixelated polarizer. The second pixelated polarizer array is disposed on the first side of the display panel, the first pixelated polarizer array is disposed between the second pixelated polarizer array and the optical path structure, and the second pixelated polarizer array includes a second pixelated polarizer. The first pixelated polarizer, the second pixelated polarizer and the first light sensor overlap in a vertical projection direction, and a polarization direction of the first pixelated polarizer is the same as a polarization direction of the second pixelated polarizer.

In the fingerprint sensing device of the present invention, the fingerprint sensing light can accurately enter into the corresponding light sensor underneath, thereby reducing the interference caused by the fingerprint sensing light received by the light sensors of adjacent pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a cross-sectional view of a fingerprint sensing device according to an embodiment of the present invention.

FIG. 2 schematically illustrates a partial top view of a pixelated polarizer array and a microlens array according to the embodiment.

FIG. 3 schematically illustrates a partial enlarged view of FIG. 1.

### DETAILED DESCRIPTION

The present invention may be understood by reference to the following detailed description, taken in conjunction with the drawings as described below. It is noted that, for purposes of illustrative clarity and being easily understood by the readers, various drawings of this disclosure show a portion of the fingerprint sensing device, and certain elements in various drawings may not be drawn to scale. In addition, the number and dimension of each element shown in drawings are only illustrative and are not intended to limit the scope of the present invention.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented.

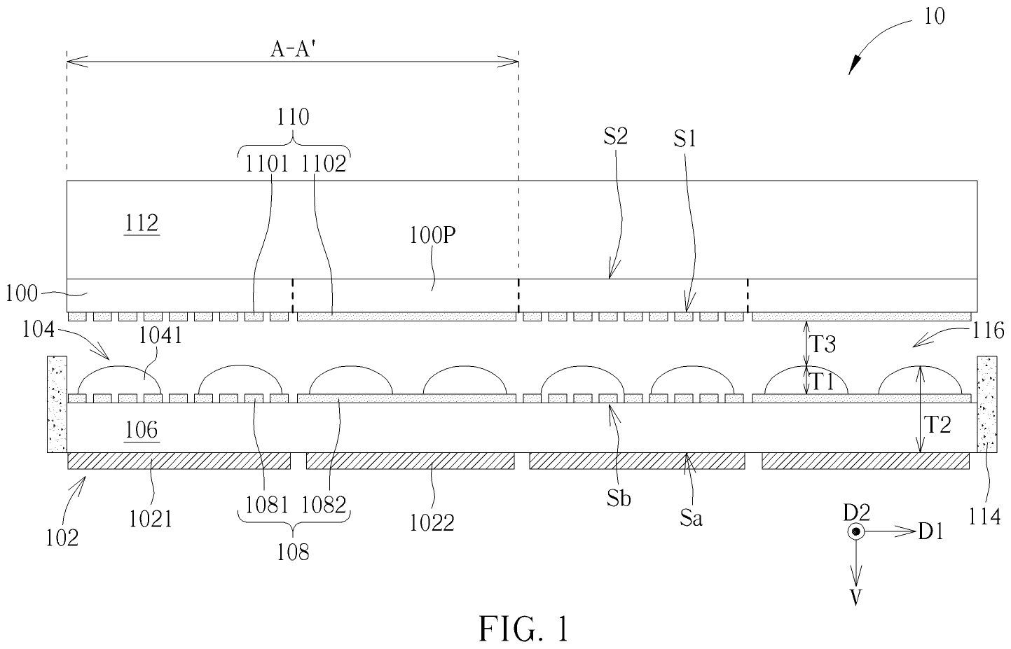

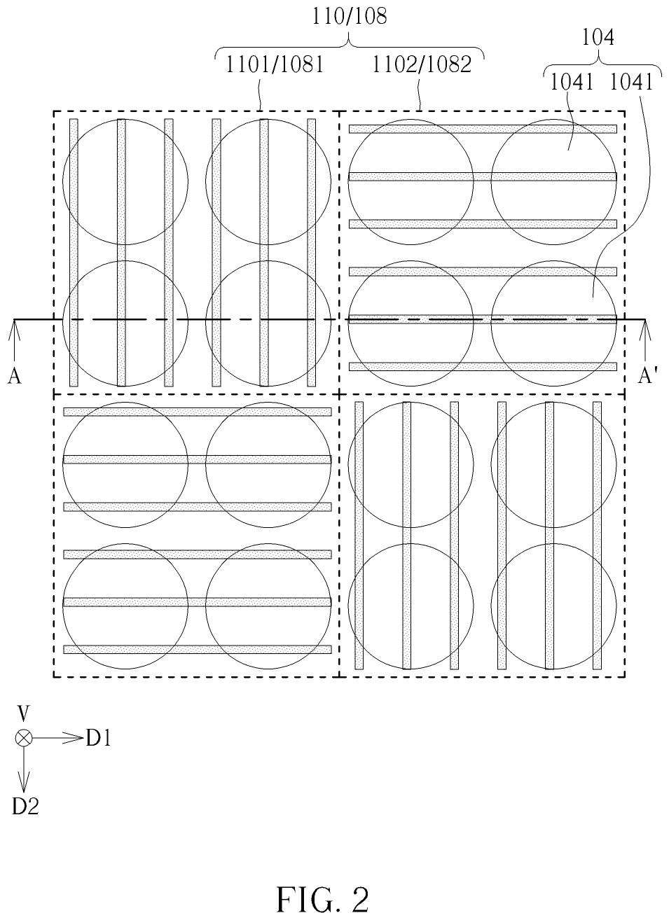

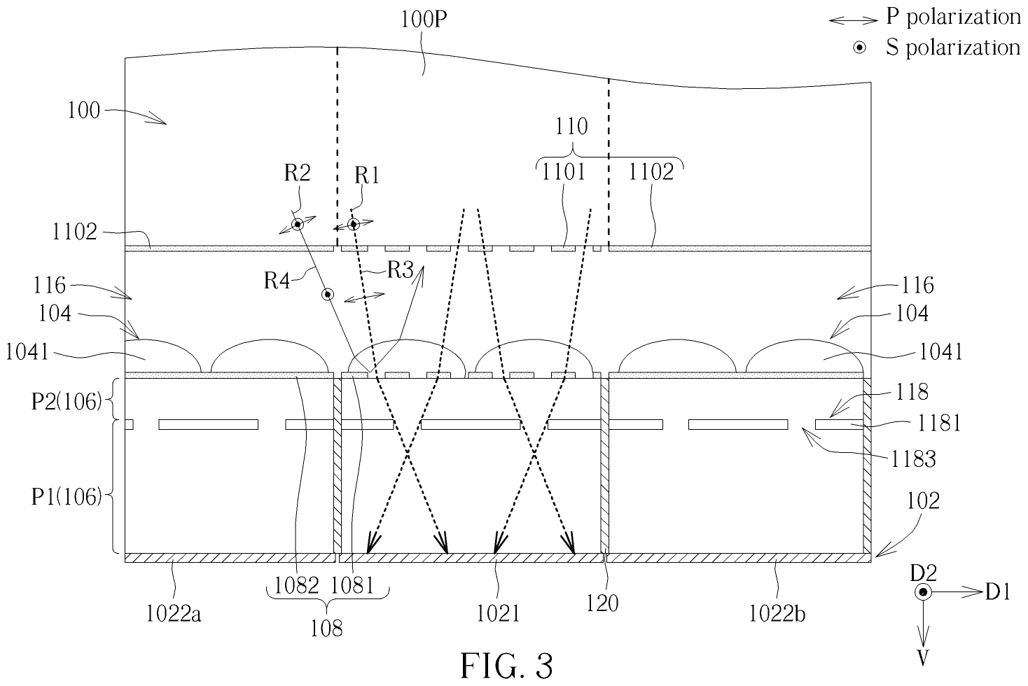

Referring to FIG. 1 to FIG. 3, FIG. 1 schematically illustrates a cross-sectional view of a fingerprint sensing device according to an embodiment of the present invention, FIG. 2 schematically illustrates a partial top view of a pixelated polarizer array and a microlens array according to the embodiment, and FIG. 3 schematically illustrates a partial enlarged view of FIG. 1. A portion of the structure in FIG. 1 corresponds to a line A-A′ in FIG. 2. As shown in FIG. 1, a fingerprint sensing device 10 of this embodiment includes a display panel 100, a light sensor array 102, a microlens array 104, an optical path structure 106, a pixelated polarizer array 108 (or referred to as a first pixelated polarizer array), a pixelated polarizer array 110 (or referred to as a second pixelated polarizer array) and a cover layer 112. The fingerprint sensing device 10 of this embodiment can be applied to smart phones, but not limited thereto.

The display panel 100 of this embodiment can be an active matrix organic light emitting diode (AMOLED) display, but not limited thereto. The display panel 100 includes a plurality of pixels 100P, the pixels 100P can emit different or the same color of light, so that the display panel 100 can provide a colorful image. In FIG. 1, the display panel 100 includes a first side S1 and a second side S2 opposite to the first side S1.

The pixelated polarizer array 110 is disposed on the first side S1 of the display panel 100, and the cover layer 112 is disposed on the second side S2 of the display panel 100. In other words, the display panel 100 is disposed between the cover layer 112 and the pixelated polarizer array 110. For example, the pixelated polarizer array 110 may be disposed on a surface of the display panel 100 on the first side S1, and the cover layer 112 may be disposed on a surface of the display panel 100 on the second side S2.

The cover layer 112 can be used to protect the display panel 100, and the cover layer 112 in this embodiment can be a transparent rigid substrate, such as a cover glass, but not limited thereto. The thickness of the cover glass may range from 500 micrometers to 1 millimeter, but not limited thereto.

As shown in FIG. 1 and FIG. 2, the pixelated polarizer array 110 includes a plurality of pixelated polarizers 1101 (or referred to as the second pixelated polarizers) and a plurality of pixelated polarizers 1102 (or referred to as the fourth pixelated polarizers). The pixelated polarizers 1101 and the pixelated polarizers 1102 are disposed alternately in a first direction D1 and/or a second direction D2. Therefore, one pixelated polarizer 1101 is disposed adjoining to one pixelated polarizer 1102 in the first direction D1 and/or the second direction D2.

In this embodiment, a polarization direction of the pixelated polarizers 1102 is different from a polarization direction of the pixelated polarizers 1101, and the polarization direction of the pixelated polarizers 1102 is perpendicular to the polarization direction of the pixelated polarizers 1101. As shown in FIG. 2, the pixelated polarizers 1101 and 1102 of the pixelated polarizer array 110 include a metal wire grid structure. The metal wires of the pixelated polarizers 1101 extend along the second direction D2, the metal wires of the pixelated polarizers 1102 extend along the first direction D1, and the first direction D1 is perpendicular to the second direction D2.

As shown in FIG. 1, the optical path structure 106 is disposed between the display panel 100 and the light sensor array 102, and the optical path structure 106 includes a first side Sa and a second side Sb opposite to the first side Sa. The light sensor array 102 is disposed on the first side Sa of the optical path structure 106, and the pixelated polarizer array 108 is disposed on the second side Sb of the optical path structure 106. In other words, the pixelated polarizer array 108 is disposed between the pixelated polarizer array 110 and the optical path structure 106. For example, the light sensor array 102 may be disposed on a surface of the optical path structure 106 on the first side Sa, and the pixelated polarizer array 108 may be disposed on a surface of the optical path structure 106 on the second side Sb.

The light sensor array 102 is disposed under the display panel 100, and the light sensor array 102 includes a plurality of light sensors 1021 (or referred to as the first light sensors) and a plurality of light sensors 1022 (or referred to as the second light sensors). As shown in FIG. 1, the light sensors 1021 are disposed corresponding to the pixelated polarizers 1101 in a vertical projection direction V, and the light sensors 1022 are disposed corresponding to the pixelated polarizers 1102 in the vertical projection direction V. The light sensors 1021 and 1022 can be disposed alternately in the first direction D1 and/or the second direction D2. Therefore, one light sensor 1021 can be disposed adjoining to one light sensor 1022 in the first direction D1 and/or the second direction D2. The light sensors can include complementary metal oxide semiconductor (CMOS) sensors, photodiodes (PD) or other photoelectric conversion devices.

As shown in FIG. 1 and FIG. 2, the pixelated polarizer array 108 includes a plurality of pixelated polarizers 1081 (or referred to as the first pixelated polarizers) and a plurality of pixelated polarizers 1082 (or referred to as the third pixelated polarizers). The pixelated polarizers 1081 are disposed corresponding to the pixelated polarizers 1101 in the vertical projection direction V, and the pixelated polarizers 1081 and the pixelated polarizers 1101 overlap in the vertical projection direction V. The pixelated polarizers 1082 are disposed corresponding to the pixelated polarizers 1102 in the vertical projection direction V, and the pixelated polarizers 1082 and the pixelated polarizers 1102 overlap in the vertical projection direction V. In this embodiment, the polarization direction of the pixelated polarizers 1081 is the same as the polarization direction of the pixelated polarizers 1101, and the polarization direction of the pixelated polarizers 1082 is the same as the polarization direction of the pixelated polarizers 1102.

Furthermore, in this embodiment, the pixelated polarizers 1081, the pixelated polarizers 1101 and the light sensors 1021 overlap in the vertical projection direction V, and the pixelated polarizers 1082, the pixelated polarizers 1102 and the light sensors 1022 overlap in the vertical projection direction V.

In addition, the pixelated polarizers 1081 and 1082 are disposed alternately in the first direction D1 and/or the second direction D2. Therefore, one pixelated polarizer 1081 is disposed adjoining to one pixelated polarizer 1082 in the first direction D1 and/or the second direction D2. The polarization direction of the pixelated polarizers 1082 is different from the polarization direction of the pixelated polarizers 1081, and the polarization direction of the pixelated polarizers 1082 is perpendicular to the polarization direction of the pixelated polarizers 1081. As shown in FIG. 2, the pixelated polarizers 1081 and 1082 of the pixelated polarizer array 108 include the metal wire grid structure. The metal wires of the pixelated polarizers 1081 extend along the second direction D2, and the metal wires of the pixelated polarizers 1082 extend along the first direction D1.

In this embodiment, the dimensions (e.g., areas) of the pixelated polarizers 1081, 1082, 1101 and 1102 may be substantially the same as the dimensions (e.g., areas) of the pixels 100P of the display panel 100. In other embodiments, the pixelated polarizers may also be polymer-based polarizers, photonic crystal polarizers or other suitable types of polarizers. As shown in FIG. 1, the pixelated polarizer arrays 108, 110 may be parallel to the light sensor array 102.

In addition, the spacing between the metal wires in the pixelated polarizers 1081, 1082, 1101 and 1102 can be adjusted corresponding to different wavelengths of the fingerprint sensing light. Therefore, visible light, infrared light and other light with suitable wavelength can be used for performing fingerprint identification in the fingerprint sensing device 10.

The microlens array 104 is disposed on the second side Sb of the optical path structure 106, and the pixelated polarizer array 108 is disposed between the microlens array 104 and the optical path structure 106. For example, the microlens array 104 may be disposed on the surface of the optical path structure 106 on the second side Sb. The microlens array 104 includes a plurality of microlenses 1041, and the microlenses 1041 can be arranged in a matrix manner (as shown in FIG. 2). As shown in FIG. 1, the microlenses 1041 in the microlens array 104 can cover the pixelated polarizers 1081 and 1082 in the pixelated polarizer array 108. In addition, each light sensor (e.g., the light sensor 1021 or the light sensor 1022) is disposed corresponding to multiple microlenses 1041, and each light sensor overlaps with multiple microlenses 1041 in the vertical projection direction V. In some embodiments, the pixelated polarizer array 108 may be disposed on the microlens array 104.

As shown in FIG. 1 and FIG. 2, the microlenses 1041 has a semicircular shape, but not limited thereto. The microlenses 1041 may include organic or inorganic and transparent or translucent materials, but not limited thereto. For example, the height T1 of the microlens 1041 ranges from 1 micrometer to 2.5 micrometers, and the height T1 of the microlens 1041 may be the distance between the top end of the microlens 1041 and the bottom surface of the microlens 1041. In addition, the distance T2 from the top end of the microlens 1041 to the light sensor (e.g., the light sensor 1021 or the light sensor 1022) is about 10 micrometers.

As shown in FIG. 1, the fingerprint sensing device 10 further includes a frame 114 disposed at the periphery of the optical path structure 106. The display panel 100 can be separated from the light sensor array 102 by the frame 114, and an air gap 116 can exist between the display panel 100 and the microlens array 104. The air gap 116 can be used to protect the microlens array 104, and the thickness T3 of the air gap 116 may range from 250 micrometers to 500 micrometers. In addition, the material of the frame 114 may include plastic, but not limited thereto.

As shown in FIG. 3, the fingerprint sensing device 10 includes a light confining structure 118 disposed between the microlens array 104 and the light sensor array 102, and the light confining structure 118 may be disposed within the optical path structure 106. The optical path structure 106 may include a first portion P1 and a second portion P2, and the first portion P1 is disposed between the second portion P2 and the light sensor array 102. The first portion P1 of the optical path structure 106 is disposed on the light sensor array 102, and the first portion P1 may include integrated circuits (IC) of the light sensors, and therefore the first portion P1 may include one or more transparent or translucent dielectric layers and one or more conductor layers inside, but not limited thereto. In this embodiment, the light confining structure 118 may be disposed in the first portion P1 of the optical path structure 106.

The light confining structure 118 includes a shielding layer 1181. In this embodiment, the shielding layer 1181 can be the uppermost conductor layer in the integrated circuits. For example, the shielding layer 1181 may be a metal layer, and the shielding layer 1181 may be a top metal layer in the integrated circuits. However, the shielding layer 1181 is not limited to the metal layer, and the shielding layer 1181 may also include other suitable opaque materials.

Additionally, the light confining structure 118 includes a plurality of openings 1183, the openings 1183 are disposed in the shielding layer 1181, and each of the openings 1183 is disposed corresponding to one of the microlenses 1041 in the vertical projection direction V. For example, a diameter of the opening 1183 ranges from 1 micrometer to 2 micrometers.

In addition, the second portion P2 of the optical path structure 106 is disposed on the first portion P1 of the optical path structure 106, and the second portion P2 may include a transparent or translucent material layer, but not limited thereto. A thickness of the material layer can range from 3 micrometers to 20 micrometers.

As shown in FIG. 3, the fingerprint sensing device 10 also includes a plurality of spacers 120. The spacers 120 can be disposed in the optical path structure 106 and extend along the vertical projection direction V, and one of the spacers 120 can be disposed between two adjacent light sensors. For example, one of the spacers 120 can be disposed between the light sensor 1021 and the light sensor 1022a adjacent thereto, and another one of the spacers 120 can be disposed between the light sensor 1021 and the light sensor 1022b adjacent thereto. The spacers 120 of this embodiment may include a metal material, but not limited thereto. The spacers 120 can reduce the interference caused by the fingerprint reflected light received by the light sensors of adjacent pixels.

The advantageous functions provided by the present invention will be detailed below. As shown in FIG. 3, a light R1 and a light R2 respectively represents the sensing light reflected by the fingerprint, and both of the light R1 and the light R2 can have multiple polarization directions. For example, both of the light R1 and the light R2 can have S polarization and P polarization, and S polarization is perpendicular to P polarization. In addition, the polarization directions of the pixelated polarizers 1081, 1101 and the pixelated polarizers 1082, 1102 are perpendicular to each other. The pixelated polarizers 1081, 1101 can block the light having S polarization, and the light having P polarization can pass through the pixelated polarizers 1081, 1101. On the other hand, the pixelated polarizers 1082, 1102 can block the light having P polarization, and the light having S polarization can pass through the pixelated polarizers 1082, 1102.

Firstly, take the light R1 as an example, the light R1 becomes a light R3 having only P polarization after the light R1 passes through the pixelated polarizer 1101. Then, the light R3 passes through the microlens 1041, and the incident angle of the light R3 is refracted and altered. Since the pixelated polarizer 1081 only allow the light having P polarization to pass through, the light R3 can pass through the pixelated polarizer 1081 and enter into the optical path structure 106. Then, the light R3 can further pass through the opening 1183 of the light confining structure 118, and the light R3 can be received by the light sensor 1021.

Next, taking the light R2 as an example, the light R2 should be received by the light sensor 1022a, but the light R2 heads toward the light sensor 1021 of the adjacent pixel. Firstly, the light R2 becomes a light R4 having only S polarization after the light R2 passes through the pixelated polarizer 1102. However, since the pixelated polarizer 1081 only allows the light having P polarization to pass through, the light R4 cannot pass through the pixelated polarizer 1081 and is reflected by the pixelated polarizer 1081. Therefore, the fingerprint sensing light of adjacent pixels can be prevented from being received by the light sensor 1021.

As shown in FIG. 3, the microlenses 1041 and the light confining structure 118 can be used to converge light to prevent the light sensor from receiving fingerprint sensing light of adjacent pixels. Although the microlenses 1041 and the light confining structure 118 can reduce the incident angle of the fingerprint sensing light to +/−10 degrees, but the thicknesses of the cover layer 112 and the air gap 116 increases the traveling distance of the sensing light since the sensing light reflected by the fingerprint still needs to pass through the cover layer 112 and the air gap 116, and therefore the light sensor may still possibly receive the fingerprint sensing light of adjacent pixels, which leads to the blurring of the fingerprint image.

In order to overcome the above problems, the pixelated polarizers 1101 and 1102 are disposed on the display panel 100 and the pixelated polarizers 1081 and 1082 are disposed between the microlens array 104 and the optical path structure 106. Two upper pixelated polarizers (such as the pixelated polarizers 1101 and 1102) or two lower pixelated polarizers (such as the polarizers 1081 and 1082) corresponding to two adjacent pixels have mutually perpendicular polarization directions, and the upper pixelated polarizer and the lower pixelated polarizer corresponding to each other in the vertical projection direction V have the same polarization direction. Therefore, the fingerprint sensing light can accurately enter into the corresponding light sensor underneath, thereby reducing the interference caused by the fingerprint sensing light received by the light sensors of adjacent pixels. Accordingly, a more accurate spatial distribution of the fingerprint sensing light can be obtained, a larger area depth of field (DOF) can be achieved, and the efficiency of fingerprint identification can be further improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fingerprint sensing device, comprising:
a display panel, comprising a first side and a second side opposite to the first side;
a light sensor array, disposed under the display panel, wherein the light sensor array comprises a first light sensor;
an optical path structure, disposed between the display panel and the light sensor array, wherein the optical path structure comprises a first side and a second side opposite to the first side, and the light sensor array is disposed on the first side of the optical path structure;
a first pixelated polarizer array, disposed on the second side of the optical path structure, wherein the first pixelated polarizer array comprises a first pixelated polarizer; and
a second pixelated polarizer array, disposed on the first side of the display panel, wherein the first pixelated polarizer array is disposed between the second pixelated polarizer array and the optical path structure, and the second pixelated polarizer array comprises a second pixelated polarizer,
wherein the first pixelated polarizer, the second pixelated polarizer and the first light sensor overlap in a vertical projection direction, and a polarization direction of the first pixelated polarizer is the same as a polarization direction of the second pixelated polarizer.

2. The fingerprint sensing device of claim 1, wherein the first pixelated polarizer array further comprises a third pixelated polarizer disposed adjoining to the first pixelated polarizer, the second pixelated polarizer array further comprises a fourth pixelated polarizer disposed adjoining to the second pixelated polarizer, a polarization direction of the third pixelated polarizer is different from the polarization direction of the first pixelated polarizer, and a polarization direction of the fourth pixelated polarizer is different from the polarization direction of the second pixelated polarizer.

3. The fingerprint sensing device of claim 2, wherein the third pixelated polarizer and the fourth pixelated polarizer overlap in the vertical projection direction, and the polarization direction of the third pixelated polarizer is the same as the polarization direction of the fourth pixelated polarizer.

4. The fingerprint sensing device of claim 3, wherein the light sensor array further comprises a second light sensor disposed adjoining to the first light sensor, and the third pixelated polarizer, the fourth pixelated polarizer and the second light sensor overlap in the vertical projection direction.

5. The fingerprint sensing device of claim 2, wherein the polarization direction of the third pixelated polarizer is perpendicular to the polarization direction of the first pixelated polarizer, and the polarization direction of the fourth pixelated polarizer is perpendicular to the polarization direction of the second pixelated polarizer.

6. The fingerprint sensing device of claim 1, wherein the first pixelated polarizer array or the second pixelated polarizer array comprises a metal wire grid structure.

7. The fingerprint sensing device of claim 1, further comprising a microlens array disposed on the second side of the optical path structure, wherein the first pixelated polarizer array is disposed between the microlens array and the optical path structure.

8. The fingerprint sensing device of claim 7, wherein the microlens array comprises a plurality of microlenses, and the microlenses and the first light sensor overlap in the vertical projection direction.

9. The fingerprint sensing device of claim 8, further comprising a light confining structure disposed between the microlens array and the light sensor array, wherein the light confining structure comprises a shielding layer and a plurality of openings, the openings are disposed in the shielding layer, and each of the openings is disposed corresponding to one of the microlenses in the vertical projection direction.

10. The fingerprint sensing device of claim 1, further comprising a cover layer disposed on the second side of the display panel.
